(19) United States
(12) Patent Application Publication
(10) Pub. No.: US 2013/0294626 A1
(43) Pub. Date: Nov. 7, 2013

(54) HEARING AID SYSTEM

(71) Applicant: Alpha Networks Inc., Hsinchu (TW)

(72) Inventor: SHUENN-TSONG YOUNG, Hsinchu (TW)

(21) Appl. No.: 13/923,517

(22) Filed: Jun. 21, 2013

Related U.S. Application Data
(62) Division of application No. 12/775,881, filed on May 7, 2010.

(30) Foreign Application Priority Data
May 11, 2009 (TW) 098115568

(51) Int. Cl. H04R 25/00

(52) U.S. Cl. CPC H04R 25/558
USPC 381/315

(57) ABSTRACT

A hearing aid system in communication with an adjusting apparatus which executes a fitting software is provided. The hearing aid system includes a hearing aid and an embedded integrated device. The hearing aid stores therein a first setting and is worn by the user. The user inputs setting data via the executed fitting software. The embedded integrated device receives the setting data from the electronic apparatus to program the hearing aid to change a first setting preciously stored in the hearing aid into a second setting associated with the setting data.

### CROSS-REFERENCE TO RELATED APPLICATION

This application is a division of an application Ser. No. 12/775,881, filed on May 7, 2010, now pending.

### FIELD OF THE INVENTION

The present invention relates to a hearing aid system, and more particularly to a hearing aid system having an integrated remote controller or embedded integrated device capable of programming a hearing aid.

### BACKGROUND OF THE INVENTION

Hearing impairment is an important issue in the medical field. Many factors such as long-term exposure to noise, genetic defect, disease, or physical trauma may cause loss of hearing. Hearing problems not only result in communication difficulty, but also affect the quality of life. At worst, hearing-impaired patients are unaware of coming dangers. Nowadays, hearing-impaired patients usually wear audio devices such as hearing aids capable of amplifying or modulating sounds to improve their hearing.

Before a hearing-impaired patient buys a hearing aid, the professional has to perform a series of fitting and fine-tuning procedures depending on the degree of hearing loss to allow the customer to have a suitable hearing aid. The steps are briefly described in the following paragraphs.

The first step is pre-fitting evaluation and audiometry (so-called hearing test). The audiologist or dispenser/hearing aid specialist performs a hearing test for the customer to obtain an audiometric report about the hearing ability.

Then, the audiologist selects a suitable hearing aid for the customer within the budget limit according to the audiometric report. During the fitting step, the audiologist operates a fitting software provided by the manufacturer of the hearing aid to set parameters of the hearing aid. The audiologist may adjust and then store several listening programs associated with different parameter settings in the hearing aid to meet the customer's hearing requirements in different listening situations.

In order to provide as satisfying hearing aid as possible, the hearing aid has to be fine-tuned repeatedly. The customer expresses to the audiologist his/her feeling about the listening and trouble encountered. Accordingly, the audiologist empirically fine-tunes parameters of the hearing aid to meet the customer's requirements and preferences.

Then, the customer may take the hearing aid on trial for several weeks. If the voice outputted by the hearing aid is not satisfying, the customer has to make an appointment with the audiologist to fine-tune the hearing aid again and again till the hearing aid is satisfactory.

The series of fitting and fine-tuning procedures are performed through a hearing-aid adjusting system. Please refer to FIG. 1, a block diagram illustrating a typical hearing-aid adjusting system. The hearing-aid adjusting system 1 includes a programming device 11 and a computer system 10 executing a fitting software 101. The programming device 11 is in communication with the computer 10 via a bluetooth, RS232, or a USB interface in a wired or wireless manner. The programming device 11 complies with HIMSA (Hearing Instrument Manufacturer Software Association) standards so as to support programming of various kinds of hearing aids. The programming device 11 is connected to the hearing aid 12 via a programming cable 13. Thus, the audiologist operates a user interface provided by the fitting software 101 installed in the computer system 10 to adjust or fine-tune parameters of the hearing aid 12.

However, according to the above description, it is known that the fine-tuning step depends very much on audiologist's experience. Even though the customer purchases the expensive and professional fitting software and programming device, it is not easy for the untrained user to rapidly and properly operate the hearing-aid adjusting system 1. That is to say, the customer has to carry the hearing aid back to the hearing-aid store again and again to perform the fine-tuning step if the adjustment is not satisfying. It is really time-consuming and inconvenient. Hence, there is a need of providing an improved hearing aid system with easy-to-use programming function to overcome the problems encountered in the prior art.

### SUMMARY OF THE INVENTION

The present invention provides a hearing aid system, which includes an integrated device capable of both controlling the operation of a hearing aid of the hearing aid system and programming the hearing aid.

In accordance with an aspect of the present invention, a hearing aid system including a hearing aid and an embedded integrated device is provided. The embedded integrated device is embedded in an electronic apparatus. The user inputs setting data through an operation interface of the electronic apparatus. The embedded integrated device receives the setting data from the electronic apparatus to program the hearing aid to change a first setting preciously stored in the hearing aid into a second setting associated with the setting data.

### BRIEF DESCRIPTION OF THE DRAWINGS

The above objects and advantages of the present invention will become more readily apparent to those ordinarily skilled in the art after reviewing the following detailed description and the accompanying drawings, in which:

FIG. 1 is a block diagram illustrating a typical hearing-aid adjusting system;

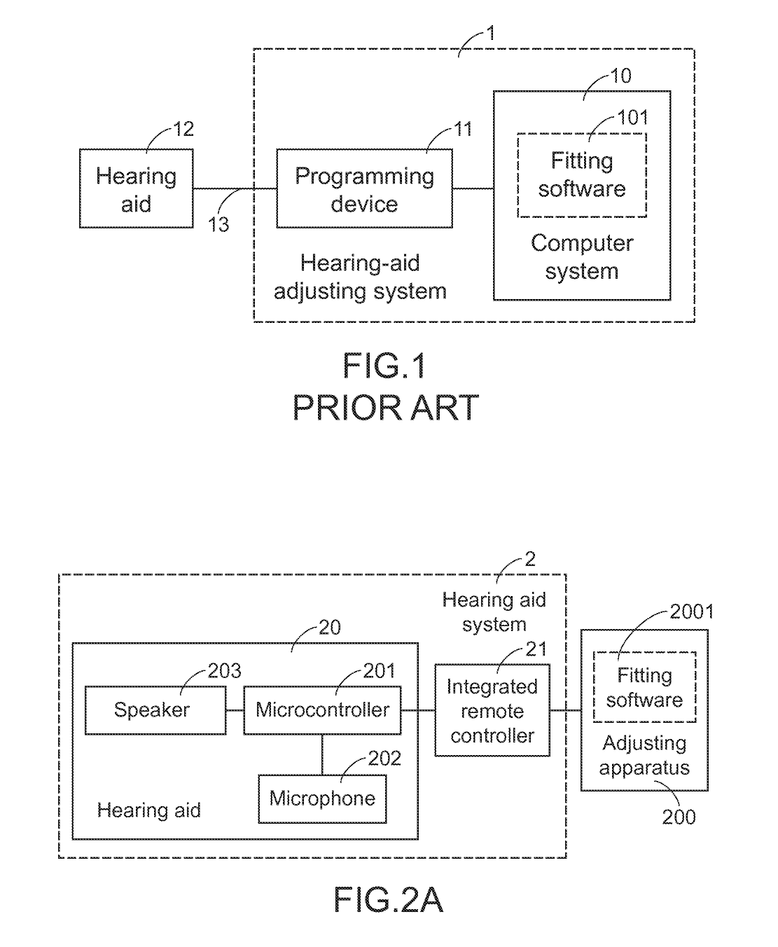

FIGS. 2A and 2B are block diagrams illustrating a first preferred embodiment of a hearing aid system according to the present invention;

FIGS. 3A and 3B are perspective views illustrating the connection among the hearing aid, the integrated remote controller and the adjusting apparatus of FIGS. 2A and 2B;

FIG. 4 is a perspective view illustrating a wireless connection between the hearing aid and the integrated remote controller according to the present invention;

FIGS. 5A and 5B are block diagrams illustrating a second preferred embodiment of a hearing aid system according to the present invention; and

FIGS. 5C and 5D are schematic diagrams illustrating the applications of the hearing aid system of FIGS. 5A and 5B.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

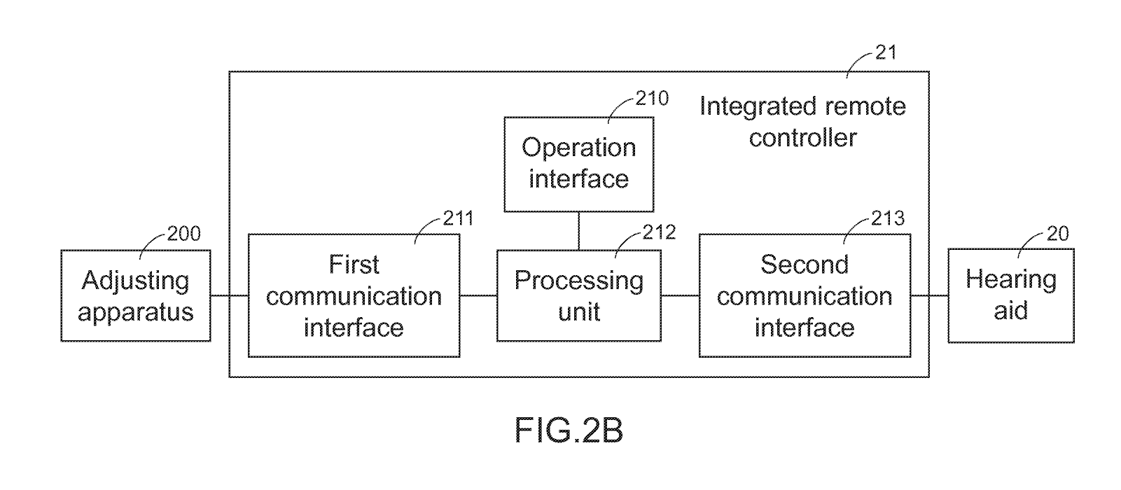

Please refer to FIG. 2A, a block diagram illustrating a preferred embodiment of a hearing aid system according to the present invention. In this embodiment, the hearing aid system 2 is in communication with an adjusting apparatus 200 executing a fitting software 2001 associated with the hearing aid 20. By operating a user interface provided by the fitting software 2001, the parameters of the hearing aid 20 can be adjusted as one wishes. The hearing aid system 2 includes a hearing aid 20 and an integrated remote controller 21. The user wears the hearing aid 20 in or behind his/her ear to aid in hearing. At least one setting is stored in the hearing aid 20. So-called one setting involves a plurality of parameters associated with the sound properties, and a setting may correspond to a listening program. The integrated remote controller 21 is in communication with the hearing aid 20 and the adjusting apparatus 200. The integrated remote controller 21 may be used for manually switching to a desired listening program among a plurality of listening programs already stored in the hearing aid 20. Furthermore, programming function is integrated into the integrated remote controller 21. Hence, the user may change the setting of the hearing aid 20 without turning to the audiologist. For example, the fitting software 2001 executed by the adjusting apparatus 200 receives user's input and the associated parameters will be burned to the hearing aid 20 via the programming function of the integrated remote controller 21 to change the original setting stored in the hearing aid 20 into a new setting.

From the description, the hearing aid 20 can be adjusted or fine-tuned through the integrated remote controller 21, an accessory to the hearing aid 20. No additional programming device is required any more. The hearing aid 20 and the integrated remote controller 21 will be described in more detail with reference to block diagrams of FIGS. 2A and 2B.

The hearing aid 20 includes a microcontroller 201, a microphone 202 and a speaker 203 (so-called receiver in hearing-aid industry). The microcontroller 201 is in communication with the integrated remote controller 21, the microphone 202 and the speaker 203, and generates a control signal in response to a command issued from the integrated remote controller 21. For example, in response to a sound-receiving command issued from the integrated remote controller 21 which may be triggered by pressing a specific button on the integrated remote controller 21, the microcontroller 201 generates a sound-receiving control signal to the microphone 202 to make the microphone 202 to start receiving the surrounding sounds. For another example, in response to a sound-outputting command issued from the integrated remote controller 21, the microcontroller 201 generates a sound-outputting control signal to the speaker 203 to make the speaker 203 to play the sounds according to the selected setting stored in the hearing aid 20. It will be helpful to the user to decide how to adjust the related parameters of the hearing aid 20 according to the output sounds. Furthermore, the received sounds for different environment sound-detecting may be recorded in the adjusting apparatus 200. On the other hand, the recorded sounds may be read out and transmitted to the hearing aid 20, and then reproduced via the speaker 203.

In an embodiment, when the user inputs setting data to the adjusting apparatus 200 to perform the fine-tuning procedure for the hearing aid 20, a recorded sound associated with a specific condition is selected and played to assist the user in determining the optimal parameters. Then, the optimal parameters are burned to the hearing aid 20 via the programming function of the integrated remote controller 21. In addition, the microphone 202 of the hearing aid 20 may detect the background sound volume or noise volume in the environment and transmit the detect result to the adjusting apparatus 200. The adjusting apparatus 200 executing the fitting software 2001 determines whether the background sound volume exceeds a threshold value. If the background sound volume exceeds the threshold value, it is possibly that the noise will affect the reliability of the fine-tuning procedure for the hearing aid 20. Hence, a warning message or sound is issued from the adjusting apparatus 200 to indicate that the current condition is improper for the adjustment. Further, a prompt message teaching how to diminish the influence of the noise may be shown on a display (not shown) of the adjusting apparatus 200.

As shown in FIG. 2B, the integrated remote controller 21 includes a processing unit 212. The integrated remote controller 21 further includes an operation interface 210 and two communication interfaces 211 and 213, all of which are in communication with the processing unit 212. The processing unit 212 receives the input setting data from the adjusting apparatus 200 through the first communication interface 211, and then converts them into programming signals to program the hearing aid 20 through the second communication interface 213. Thus, the original setting stored in the hearing aid 20 is replaced by a new setting. The operation interface 210, for example buttons (not shown), generates an operation signal in response to the use of the operation interface 210 such as pressing one button. The processing unit 211 may issue command to the hearing aid 20 according to the operation signal. The command may include but not limited to increasing volume, decreasing volume, switching to a specific listening program (setting of the hearing aid 20), switching to a previous/next listening program, actuating the microphone 202 or the speaker 203 and the like.

In particular, the hearing aid system 2 according to the present invention can give an audiometry including an air-conduction hearing threshold test, an air-conduction most comfortable level test, or an air-conduction un-comfortable level test to the user. During the audiometry, the speaker 203 outputs many test sounds and the user uses the operation interface 210 to respond to the test sounds. To use the operation interface 210 is easier and more convenient than to use a known input device of the adjusting apparatus 200 such as a keyboard. The user only has to press few buttons of the operation interface 210 of the integrated remote controller 21 to finish the audiometries, and no complicated input device is required. In an embodiment, the hearing aid 20 may receive signals from an audio line so that the hearing aid 20 may be connected to a mobile phone, a radio, a computer to allow the user directly listen voice through the speaker 203 from the mentioned audio output apparatus to eliminate the noise interference.

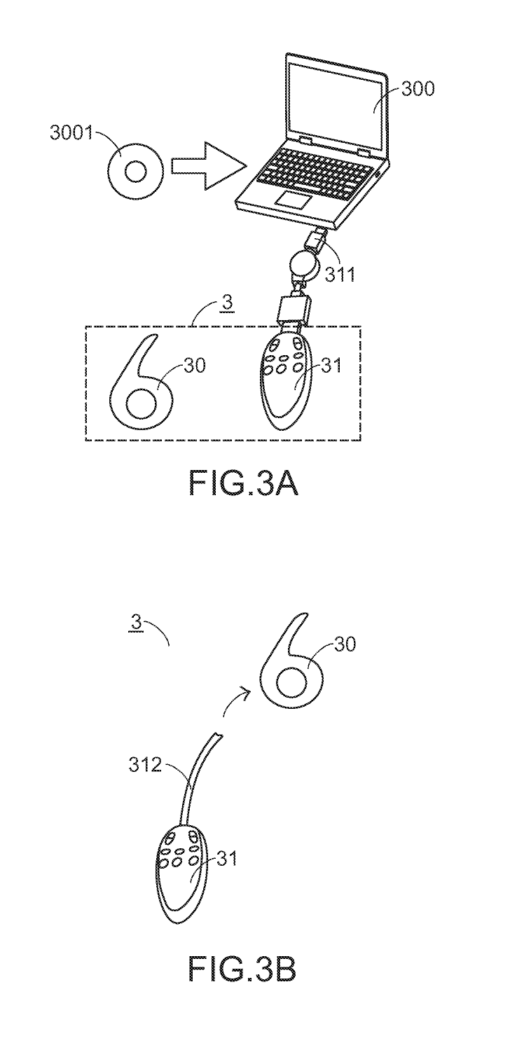

Please refer to FIGS. 3A and 3B illustrating the connection of the hearing aid system. In this embodiment, the adjusting apparatus is implemented by a notebook computer 300 which executes a fitting software 3001. Certainly, the adjusting apparatus may be implemented by other electronic apparatus such as personal computer, PDA, or mobile phone. The hearing aid system 3 includes a hearing aid 30 and an integrated remote controller 31 connected to the notebook computer 300 via a USB interface 311. The fitting software 3001 provides a graphical user interface shown on the display of the notebook computer 300. During the fine-tuning procedure for the hearing aid 30, the user inputs desired setting data by operating the graphical user interface, and the input setting data are transmitted to the integrated remote controller 31 through the USB interface 311. By connecting the integrated remote controller 31 to the hearing aid 30 via a programming line 312, programming signals converted from the input setting data are issued from the integrated remote controller 31 to modify the setting of the hearing aid 30.

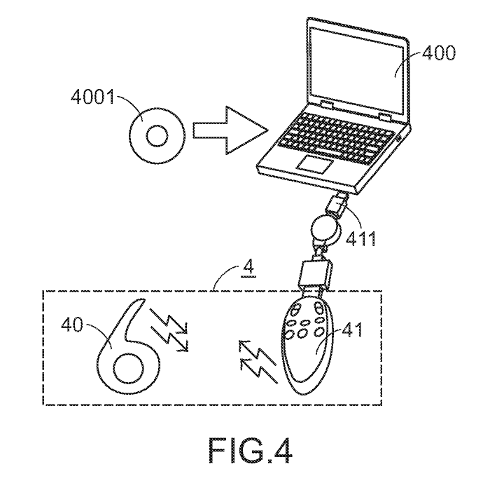

In fact, the hearing aid and the integrated remote controller can be connected in a wireless manner. Please refer to FIG. 4 illustrating this connection mode. In this embodiment, the adjusting apparatus is implemented by a notebook computer 400 which executes a fitting software 4001. The hearing aid system 4 includes a hearing aid 40 and an integrated remote controller 41 connected to the notebook computer 300 via a USB interface 411. The fitting software 4001 provides a graphical user interface shown on the display of the notebook computer 400. During the fine-tuning procedure for the hearing aid 40, the user inputs desired setting data by operating the graphical user interface, and the input setting data are transmitted to the integrated remote controller 41 through the USB interface 411. It is to be noted that the integrated remote controller 41 transmits wireless programming signals to the hearing aid 40 to burn the setting into the hearing aid 40. The wireless programming signals may be infrared signals or RF signals.

Alternatively, the USB connection between the hearing aid and the notebook computer can be replaced by known wireless connection, for example, Bluetooth connection.

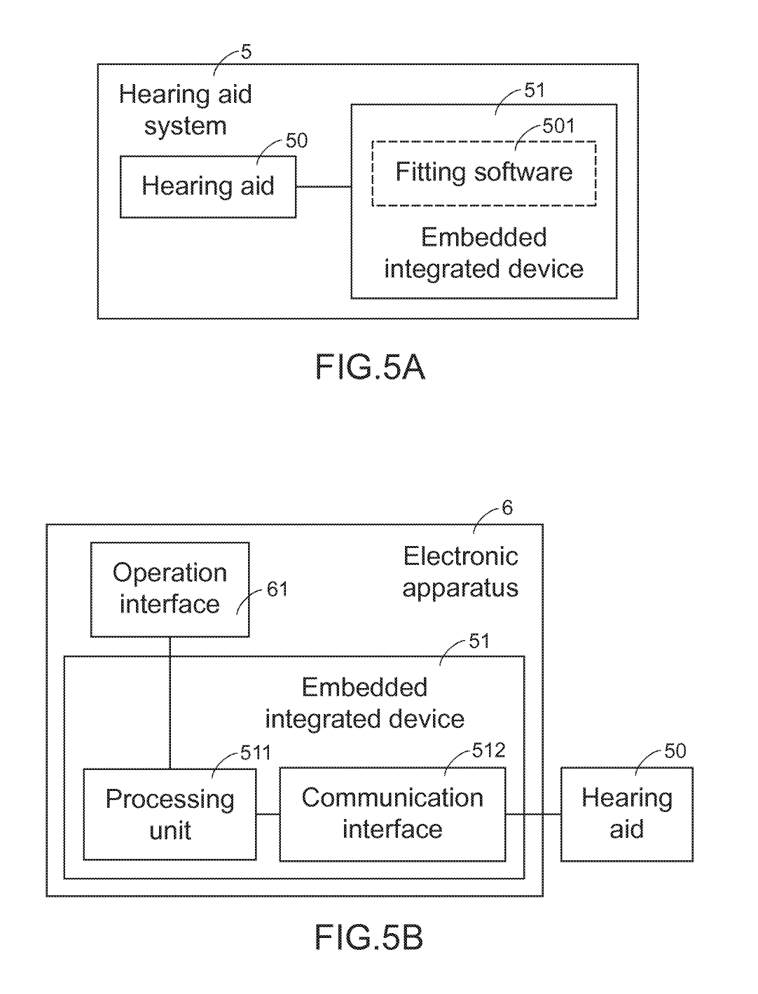

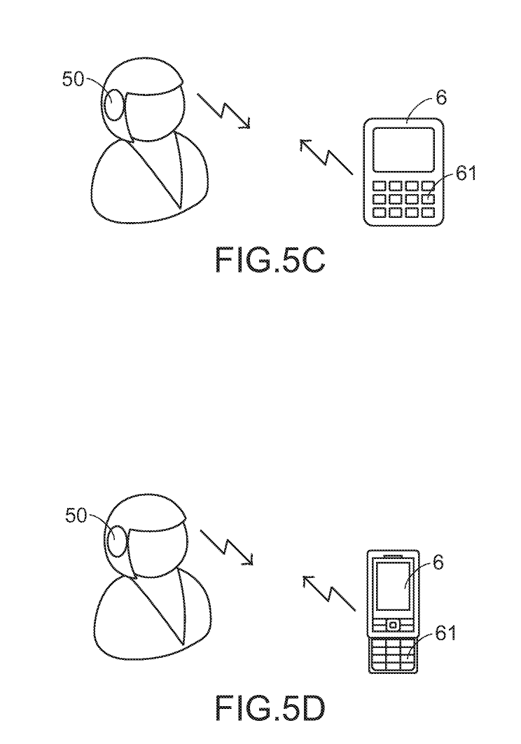

Please refer to FIGS. 5A and 5B, block diagrams illustrating another preferred embodiment of a hearing aid system according to the present invention. The hearing aid system 5 includes a hearing aid 50 and an embedded integrated device 51 which executes a fitting software 501 associated with the hearing aid 50. The user wears the hearing aid 50 in or behind his/her ear to aid in hearing. The embedded integrated device 51 is embedded in a portable electronic apparatus 6 which usually provides operation interface 61 and a display (not shown) showing a user interface provided by the fitting software 501. At least one setting is stored in the hearing aid 50. The embedded integrated device 51 has similar functions to the above-described integrated remote controller. That is, the embedded integrated device 51 can be used for manually switching the desired listening programs stored in the hearing aid 50 by operating the operation interface 61 of the portable electronic apparatus 6. Furthermore, programming function is also integrated into the embedded integrated device 51. The fitting software 501 executed by the embedded integrated device 51 receives user's input and the associated parameters will be burned to the hearing aid 50 in a wired or wireless manner to change the original setting stored in the hearing aid 50 into a new setting. No additional programming device is required, either.

As shown in FIG. 5B, the embedded integrated device 51 includes a processing unit 511 and a communication interface 512 in communication with each other. The processing unit 511 is connected to the operation interface 61 of the electronic apparatus 6. The processing unit 511 receives the setting data inputted through the operation interface 61 and then converts them into programming signals to program the hearing aid 50 through the communication interface 512. Thus, the original setting stored in the hearing aid 50 is replaced by a new setting. In addition, the processing unit 511 may issue command to the hearing aid 50 in response to the use of the operation interface 61. The command may include but not limited to increasing volume, decreasing volume, switching to a specific listening program (setting), switching to a previous/next listening program, actuating a microphone or a speaker of the hearing aid 50 and the like. The detailed structure of the hearing aid 50 has been described with reference to FIG. 2A and is not repeated herein.

FIGS. 5C and 5D illustrate the applications of the hearing aid system. The embedded integrated device 51 may be embedded into a PDA or a mobile phone 6. By operating the buttons 61 on the PDA or mobile phone 6, the embedded integrated device 51 executing the fitting software 501 issues corresponding signals to control or program the hearing aid 50.

In conclusion, the hearing aid system of the present invention includes an integrated device integrating the controlling and programming function. The integrated device may be implemented in a form of a remote controller or an embedded device. Hence, the user can program or fine-tune the hearing aid alone. The integrated device is designed as a standard accessory to the hearing aid, and it is not necessary to purchase an additional programming device for fine-tuning the hearing aid. Hence, the present invention provides an economic and convenient approach compared with the conventional hearing aid system.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A hearing aid system, comprising:
a hearing aid to be worn by a user and storing therein a first setting; and;
an embedded integrated device embedded in an electronic apparatus and being in communication with the hearing aid for controlling operation of the hearing aid and receiving setting data from the electronic apparatus to program the hearing aid by changing the first setting into a second setting associated with the setting data, wherein the embedded integrated device executes a fitting software to receive the setting data inputted through an operation interface of the electronic apparatus by the user.

2. The hearing aid system according to claim 1 wherein the embedded integrated device comprises:
a processing unit for receiving the setting data from the electronic apparatus and converting the setting data into programming signals; and
a communication interface in communication with the processing unit and the hearing aid for transmitting the programming signals to the hearing aid to program the hearing aid.

3. The hearing aid system according to claim 2 wherein the programming signals are transmitted from the embedded integrated device to the hearing aid via a programming cable.

4. The hearing aid system according to claim 2 wherein the programming signals are wireless programming signals comprising infrared signals or RF signals.

5. The hearing aid system according to claim 1 wherein the hearing aid comprises:
a microcontroller in communication with the embedded integrated device for generating a control signal in response to a command issued from the embedded integrated device;
a microphone in communication with the microcontroller for receiving sounds in response to the control signal when the command is a sound-receiving command; and
a speaker in communication with the microcontroller for outputting sounds according to a selected setting in response to the control signal when the command is a sound-outputting command.

6. The hearing aid system according to claim 5 wherein the embedded integrated device processes the received sounds and the speaker outputs the processed sounds to allow the user to input the setting data based on the outputted sounds.

7. The hearing aid system according to claim 5 wherein the embedded integrated device issues a warning message before the hearing aid is programmed when the volume of the received sounds exceeds a threshold volume.

8. The hearing aid system according to claim 5 wherein the hearing aid receives sounds from an audio line and the sounds are outputted through the speaker, the audio line being connected to a mobile phone, a computer or a radio.

9. The hearing aid system according to claim 5 wherein the speaker outputs test sounds during an audiometry comprising an air-conduction hearing threshold test, an air-conduction most comfortable level test, or an air-conduction un-comfortable level test.

10. The hearing aid system according to claim 1 wherein the embedded integrated device is embedded in a personal computer, a notebook computer or a mobile phone.
